(19) United States
(12) Patent Application Publication
(10) Pub. No.: US 2010/0050836 A1
(43) Pub. Date: Mar. 4, 2010

(54) Machine tool protective device

(76) Inventors: Juergen Seidel, Esslingen (DE); Juergen Hasch, Stuttgart (DE); Alexander Werner Hees, Bietigheim-Bissingen (DE)

Correspondence Address: KENYON & KENYON LLP, ONE BROADWAY, NEW YORK, NY, 10004, US

(21) Appl. No.: 12/583,845

(22) Filed: Aug. 27, 2009

(30) Foreign Application Priority Data
Aug. 28, 2008 (DE) 10 2008 041 653.3

(51) Int. Cl. B26D 7/22; B27G 19/02

(52) U.S. Cl. 83/13; 83/860; 83/440.2; 83/58

(57) ABSTRACT

A machine tool protective device for a machine tool, having a monitoring unit which is provided for monitoring a protective region assigned to a tool. It is provided that the machine tool protective device has a guiding unit, which is provided for guiding the protective region as a function of a position of the tool.

### RELATED APPLICATION INFORMATION

The present application claims priority to and the benefit of German patent application no. 10 2008 041 653.3, which was filed in Germany on Aug. 28, 2008, the disclosure of which is incorporated herein by reference.

### FIELD OF THE INVENTION

The present invention is based on a machine tool protective device.

### BACKGROUND INFORMATION

One machine tool protective device for a machine tool is already known. The machine tool protective device has a monitoring unit for monitoring a protective region associated with a tool.

### SUMMARY OF THE INVENTION

The exemplary embodiments and/or exemplary methods of the present invention relates to a machine tool protective device for a machine tool, having a monitoring unit which is provided for monitoring a protective region associated with a tool.

It is provided that the machine tool protective device has a guiding unit which is provided to guide the protective region as a function of a position of the tool. In this connection, “provided” is understood to be particularly especially equipped and/or specially designed and/or specially programmed. Furthermore, a “protective region” should be understood to mean particularly a region composed of points having the smallest distance from a tool, especially a cutting edge of the tool, such as a saw edge, 10 cm at the most and especially advantageously 5 cm maximum. The guiding unit may be provided for a self-acting or automatic guiding of the protective region.

By “monitoring unit” one should furthermore understand particularly a unit which, using a monitoring signal, especially a radar signal and/or an additional signal that appears meaningful to one skilled in the art, is provided for the monitoring or detecting of living tissue, such as a hand of the operator in the protective region, for the protection of the operator. Furthermore, by “position of a tool” one should particularly understand one of several positions of the tool which the tool is able to take up in the operation of the machine tool. The tool may be supported in a tool carrier, the tool carrier, together with the tool, being variable in its position, especially in its height and/or angle of inclination, and the protective region thus being adjustable as a function of a position of the tool carrier in an operation of the machine tool.

By the design according to the exemplary embodiments and/or exemplary methods of the present invention, advantageous monitoring of a current danger region, which is situated, in particular, around a working edge or a saw edge of the tool, may be achieved in the operation of the machine tool, and with that, great safety for an operator of the machine tool. In addition, the protective region may be efficiently minimized, and one may do without a non-advantageous expansion of the protective region which covers all possible positions of the tool.

It is further provided that the guiding unit have at least one detecting arrangement for recording the position of the tool. The detecting arrangement in this case may be a sensor and/or is coupled mechanically with the tool, or rather the tool carrier and/or is an additional detecting arrangement that appears meaningful to one skilled in the art. Because of this design, one may advantageously achieve an automated detection of a position of the tool and/or a tool carrier. In addition, going along with this, the safety of a machine tool is advantageously able to be increased for an operator by achieving an automatic guiding by the guiding unit, using the detected position of the tool and/or a tool carrier.

It is also provided that the guiding unit is at least partly formed of a mechanical guiding unit, whereby, in a constructively simple manner, the protective region, especially a position of the protective region, is able to be coupled to a position of the tool or the tool carrier. The mechanical guiding unit may, in this connection, have one or more guiding arrangement, such as a connecting link and/or rods and/or a tackle and/or any other component appearing meaningful to one skilled in the art.

In still another embodiment of the present invention it is provided to have the guiding unit be at least partially formed by an electronic guiding unit. One may thereby achieve an especially compact and space-saving guiding unit. Alternatively, the guiding unit may especially advantageously be formed of a combination of a mechanical and an electrical guiding unit.

It is also provided that the guiding unit have a bearing unit which stores the monitoring unit in a movable manner, whereby an effective and flexible monitoring of the protective region may advantageously be achieved. In addition, the monitoring unit in this instance is able to be moved to a position that is advantageous for the respective position of the tool and/or the tool carrier, so that a mutual obstruction between monitoring unit and tool and/or tool carrier is advantageously prevented. The bearing unit may have at least one bearing element which, in particular, is provided for an active position change of the monitoring unit, or actively contributes to a position change of the monitoring unit.

Moreover, it is provided that the machine tool protective device have a tool guiding unit, the bearing unit being developed at least partially in one piece with the tool guiding unit. In this connection, by a “tool guiding unit” one should particularly understand a unit and/or a component which is understood to be for bearing support and/or guidance, especially in a bearing support and/or guidance that is changeable in a position of the tool and/or the tool carrier, of the tool and/or the tool carrier. Furthermore, “in one piece” should be understood particularly as in one part and/or formed by one casting and/or as one component. The tool guiding unit may be developed in one piece with one or more bearing elements of the bearing unit. In this instance, a protective region guiding may be achieved constructively in a simple manner, while saving additional components and costs.

Especially advantageously, the machine tool protective device has a protective cover that is changeable with the tool in its position; the monitoring unit being situated at least partially on the protective cover. The monitoring unit in this instance may be fastened to the protective cover, so that the monitoring unit is arranged in a stationary mount with respect to the tool, particularly a working edge and/or a saw edge of the tool, and, in this context, always maintains an effective monitoring region of the tool or of the working edge and/or the saw edge.

It is also provided that the bearing unit be provided for a position change of the monitoring unit with respect to the tool, whereby an effective monitoring position of the monitoring unit for monitoring the protective region, especially in the vicinity of a working edge and/or a saw edge of the tool is advantageously able to be achieved.

It is further provided that the guiding unit have at least one setting arrangement, which is provided for changing a radiation parameter of a monitoring signal of the monitoring unit. In this connection, by “radiation parameter” one should particularly understand a parameter of a monitoring signal that is formed by a width of an angle of radiation and/or a position of the angle of radiation. The protective region may advantageously be set with respect to a width of the angular range and/or a positioning of the angular range, adjusted to the position of the tool and/or the tool carrier, in the operation of the machine tool protective device.

Moreover, the exemplary embodiments and/or exemplary methods of the present invention relates to a machine tool, especially a saw machine tool, having a machine tool protective device. The saw machine tool is particularly advantageously formed by a circular saw having a tool formed to be changeable in its position, formed by a circular saw blade. The machine tool protective device may basically be used in all machine tools that appear meaningful to one skilled in the art, in which the monitoring of a protective region, assigned to a tool, makes sense.

Furthermore, it is provided that the machine tool have a working surface that is provided for placing a workpiece that is to be processed, the bearing unit essentially supporting the monitoring unit movably in parallel and/or perpendicular to the working surface. In this connection, by “essentially in parallel” one should understand particularly that a movement along a direction takes place which includes an angle with respect to the working surface of at most 25°, advantageously of at most 15° and especially advantageously of at most 5°. Furthermore, by “essentially perpendicular” one should understand especially that a movement along a direction takes place which includes an angle with respect to the working surface of at most 115°, advantageously of at most 105° and especially advantageously of at most 95°. Because of this embodiment of the present invention, a constructively simple bearing arrangement and/or movement of the monitoring unit inside the machine tool are able to be achieved.

It is further provided that the monitoring unit is situated in a stationary mount relative to the working surface, whereby a particularly safe positioning of the monitoring unit and a simple activation of the monitoring unit is advantageously able to be achieved, while saving on further components.

In addition, the exemplary embodiments and/or exemplary methods of the present invention relates to a method for guiding a protective region for a machine tool monitoring device. In this connection, it is provided that a protective region of a monitoring unit is guided as a function of the position of a tool. By the design according to the exemplary embodiments and/or exemplary methods of the present invention, advantageous monitoring of a current danger region, which is situated, in particular, around a working edge or a saw edge of the tool, may be achieved in the operation of the machine tool, and, with that, great safety for an operator of the machine tool.

Further advantages result from the following description of the drawings. The drawings shows exemplary embodiments of the present invention. The drawings, the specification and the claims contain numerous features in combination. One skilled in the art will expediently examine the features not only individually, but also combine them to meaningful combinations.

### BRIEF DESCRIPTION OF THE DRAWINGS

FIG. 1 shows a machine tool formed from a circular saw, having a machine tool protective device, in a schematic view.

FIG. 2 shows a first variant of the machine tool protective device, having a mechanical guiding unit, in a schematic section.

FIG. 3 shows a second variant of the machine tool protective device, having a monitoring unit that is movable with respect to a tool, in a schematic section.

FIG. 4 shows a third variant of the machine tool protective device, having an electronic guiding unit, in a schematic section.

### DETAILED DESCRIPTION

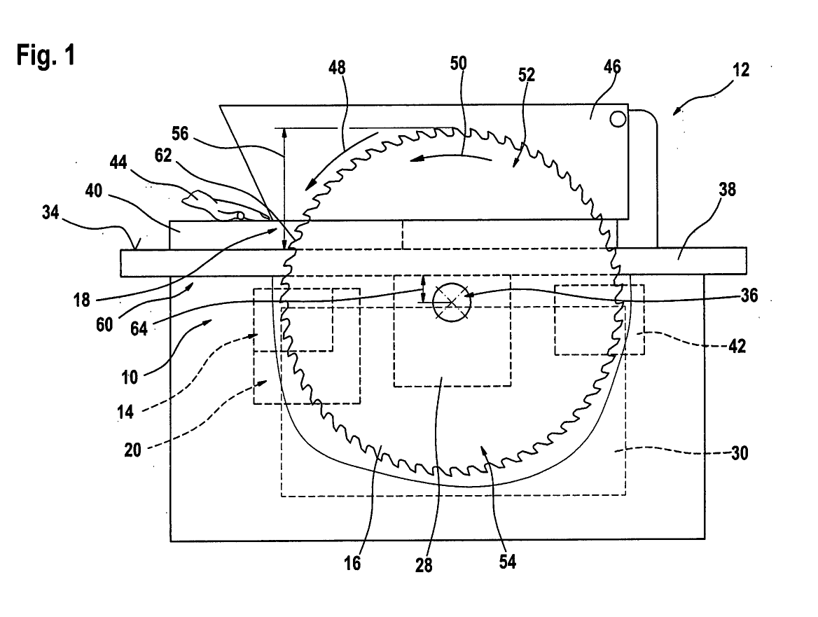

FIG. 1 shows a machine tool 12 formed by a circular saw bench. The circular saw bench includes a tool carrier 36, in which a tool 16, formed by a circular saw blade, is situated. In a mounted state, tool 16 extends through a recess, that is not shown in greater detail, in a workbench 38 of machine tool 12. Workbench 38 has a working surface 34 that is provided to place a workpiece 40 on, which is being processed in the operation of machine tool 12. Machine tool 12 also includes a motor unit 42, by which tool 16 is driven during operation. Machine tool 12 furthermore has a machine tool protective device 10, which is provided to protect an operator 44 from tool 16 during operation of machine tool 12.

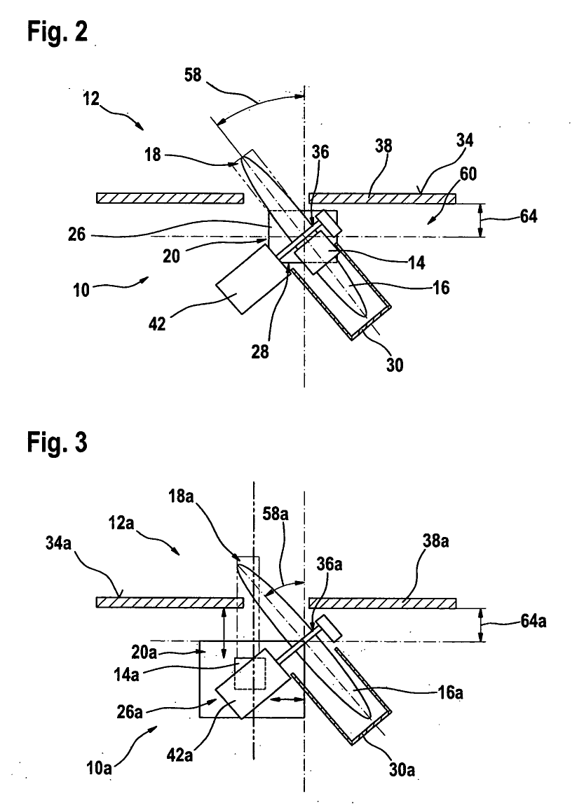

Machine tool protective device 10 has a protective cover 46, which runs along a circumferential direction 48 of tool 16, which is situated parallel to the direction of rotation 50 of tool 16, about a partial region 52 of tool 16 that extends out of workbench 38. Furthermore, machine tool protective device 10 has a protective cover 30, which is situated along circumferential direction 48 about partial region 54 of tool 16 situated within a housing of machine tool 12, and a tool guiding unit 28, which is provided for a movable support and/or guidance of tool 16, together with tool carrier 36 and protective cover 30. Tool 16 together with tool carrier 36 and protective cover 30 may be varied, in this instance, both in its height 56 to which it extends from workbench 38 or at a distance 64 and/or a height of tool carrier 36 with respect to workbench 38 and at an angle of inclination 58, which tool 16 includes with workbench 38 (FIGS. 1 and 2).

In addition, machine tool protective device 10 has a monitoring unit 14, which is situated on a side 60 of workbench 38 that faces away from working surface 34. Monitoring unit 14 is provided for monitoring a protective region 18 facing a tool 16. In this connection, a possible contact of operator 44 with tool 16 is detected, in good time, by monitoring unit 14 during the operation of machine tool 12, and, if necessary, a requisite protective measure is initiated, such as the braking of tool 16, an immediate operating stop of machine tool 12 etc.

For this purpose, monitoring unit 14 has a transmitting unit, that is not shown in greater detail, which sends out a protective signal formed by a radar signal, which sets protective region 18. In one alternative embodiment, the protective signal is able to be formed by other signals that appear meaningful to one skilled in the art. The protective signal is reflected by objects located in protective region 18, and received and evaluated by monitoring unit 14. For this purpose, monitoring unit 14 has a receiving unit and an evaluation unit. Protective region 18 is particularly situated in a region of ca. 5 cm about a working edge 62 or a saw edge of tool 16 (FIGS. 1 and 2).

Furthermore, machine tool protective device 10 has a guiding unit 20 which is provided for guiding protective region 18 as a function of a position of tool 16, together with tool carrier 36. Guiding unit 20 is furthermore formed by a mechanical guiding unit 20, and has a bearing unit 26 which is provided for a movable bearing and or guiding arrangement of monitoring unit 14. Bearing unit 26 is developed in one piece, or rather as a component with tool guiding unit 28, so that when there is a position change of tool 16 or tool carrier 36, at the same time, monitoring unit 14 is changed in its position together with tool 16 and tool carrier 36. For this purpose, monitoring unit 14 is situated on protective cover 30 of tool 16, and fastened to it. Protective region 18, in this instance, may already be adjusted, during the mounting of monitoring unit 14 in machine tool 12, to working edge 62 and the saw edge, and consequently, because of the one-piece design of bearing unit 26 with tool guiding unit 28, protective region 18 may advantageously be changed in its position together with tool 16 (FIG. 2).

During the operation of machine tool 12, if tool 16 is changed in its height 56 or its angle of inclination 58 with respect to working surface 34, in this instance, protective cover 30 and motor unit 42 also being changed in their position, together with tool 16, monitoring unit 14 is hereby also changed in its position with respect to working surface 34. An alignment of monitoring unit 14 with respect to tool 16 remains the same in every position, because of the positioning of monitoring unit 14 on protective cover 30, so that an advantageous protective region 18 around tool 16 is effectively monitored and detected in the operation of machine tool 12.

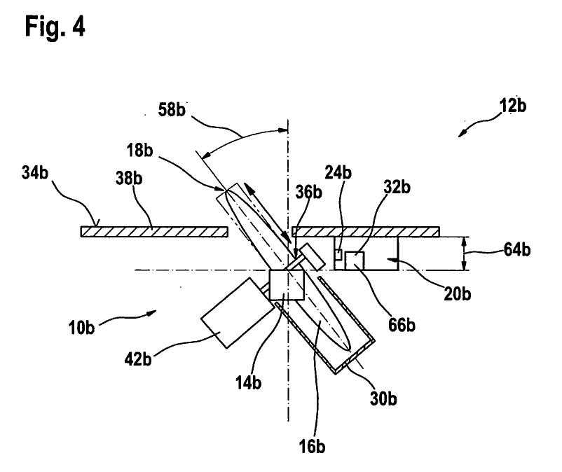

In FIGS. 3 and 4, exemplary embodiments are shown that are alternatives to those in FIGS. 1 and 2. Components, features and functionalities that essentially remain the same are basically numbered using the same reference symbols. However, in order to distinguish the exemplary embodiments, letters a and b are added to the reference symbols of the exemplary embodiments. The subsequent description is restricted essentially to the differences from the exemplary embodiment in FIGS. 1 and 2, reference being made to the description of the exemplary embodiment in FIGS. 1 and 2 with respect to components, features and functionalities that remain the same.

FIG. 3 shows a machine tool protective device 10a that is developed alternatively to FIG. 2, having a monitoring unit 14a and a guiding unit 20a. Machine tool protective device 10a has a bearing unit 26a which is provided for a position change of monitoring unit 14a relative to a tool 16a and a tool carrier 36a in the operation of a machine tool 12a. In this instance, bearing unit 26a may be a bearing arrangement, not shown in greater detail, made up of a connecting link guide, of guide rods, of tackles and/or of a further bearing arrangement that appear meaningful to one skilled in the art. In the operation of machine tool 12a, using bearing unit 26a, the position of monitoring unit 14a is able to be changed essentially perpendicular and essentially in parallel to a working surface 34a of machine tool 12a, as is indicated by the arrows in FIG. 3.

In addition, bearing unit 26a is coupled mechanically with tool guiding unit 28a, so that a position change of tool 16a together with tool carrier 36a leads automatically to a position change of monitoring unit 14a. Alternatively to this, guiding unit 20a may also have a detecting arrangement formed by a sensor, which is provided for detecting a position of tool 16a in the operation of machine tool 12a. The sensor is able to detect the position of tool 16a visually and/or it may be coupled to a setting arrangement for setting a tool position, so that an appropriate position parameter is transmitted to the sensor, depending on the position of tool 16a.

FIG. 4 shows an additional, alternatively developed machine tool protective device lob having a monitoring unit 14b and a guiding unit 20b. Monitoring unit 14b is situated in a stationary manner with respect to a working table 38b or a working surface 34b of the working table 38b in a machine tool 12b. In this instance, guiding unit 20b is formed by an electronic guiding unit 20b having a computing unit 66b formed from a setting arrangement 32b, and provided for the purpose of changing a protective region 18b of monitoring unit 14b with the aid of a change of a radiation parameter of a monitoring signal of monitoring unit 14b in its position. The radiation parameter, in this instance, may be formed by a width of a radiated angular range, a position of the angular range, a position of the angular range with respect to a working surface 34b of machine tool 12b, for instance, using a turning movement of an antenna, and/or further radiation parameters that appear meaningful to one skilled in the art.

In order to detect a position of tool 16b or tool carrier 36b, guiding unit 20b has a detecting arrangement 24b that is formed of a sensor that is provided, in the operation of machine tool 12b, to detect a position of tool 16b. With the aid of the recorded position of tool 16b, computing unit 66b calculates an advantageous position of protective region 18b, and then calculates a setting for one or more radiation parameters of a transmission unit of monitoring unit 14b, that is not shown in greater detail. Finally, computing unit 66b changes the radiation parameters of the transmission unit to the calculated values of the radiation parameters, and, with that, a position of the protective region 18b is also changed.

Moreover, in a further development of the exemplary embodiments and/or exemplary methods of the present invention it is also conceivable that guiding unit 20 might be formed of a combination of a mechanical and an electronic guiding unit 20. In this connection, both monitoring unit 14 may be changed in its position and a radiation parameter of a transmission unit of monitoring unit 14 may be varied.

What is claimed is:

1. A machine tool protective device for a machine tool, comprising:
a guiding unit to guide the protective region as a function of a position of the tool; and
a monitoring unit to monitor a protective region assigned to a tool, wherein the monitoring unit includes the guiding unit.

2. The machine tool protective device of claim 1, wherein the guiding unit is formed at least partially of a mechanical guiding unit.

3. The machine tool protective device of claim 1, wherein the guiding unit is formed at least partially of an electronic guiding unit.

4. The machine tool protective device of claim 1, wherein the guiding unit includes at least one detecting arrangement to detect the position of the tool.

5. The machine tool protective device of claim 1, wherein the guiding unit includes a bearing unit which movably supports the monitoring unit.

6. The machine tool protective device of claim 5, wherein the bearing unit is developed at least partially in one piece with the tool guiding unit.

7. The machine tool protective device of claim 6, further comprising:
a protective cover that is changeable together with the tool in its position, the monitoring unit being situated at least partially on the protective cover.

8. The machine tool protective device of claim 5, wherein the bearing unit provides a position change of the monitoring unit with respect to the tool.

9. The machine tool protective device of claim 1, wherein the guiding unit has at least one setting arrangement provided for a change of a radiation parameter of a monitoring signal of the monitoring unit.

10. A saw machine tool, comprising:
a machine tool protective device, including:
a guiding unit to guide the protective region as a function of a position of the tool; and
a monitoring unit to monitor a protective region assigned to a tool, wherein the monitoring unit includes the guiding unit.

11. The machine tool of claim 10, wherein the guiding unit includes a bearing unit which movably supports the monitoring unit, and wherein there is a working surface for positioning a workpiece that is to be processed, the bearing unit movably supporting the monitoring unit at least one of essentially in parallel and essentially perpendicular to the working surface.

12. The machine tool at least of claim 10, wherein the monitoring unit is situated in a stationary manner relative to the working surface.

13. A method for guiding a protective region for a machine tool protective device, the method comprising:
guiding a protective region of a monitoring unit as a function of a position of a machine tool;
wherein the machine tool protective device for the machine tool includes a guiding unit to guide the protective region as a function of the position of the tool, and a monitoring unit to monitor a protective region assigned to the tool, the monitoring unit including the guiding unit.
